(19) United States
(12) Patent Application Publication
(10) Pub. No.: US 2012/0191848 A1
(43) Pub. Date: Jul. 26, 2012

(54) METHOD AND APPARATUS FOR DISCOVERING PEOPLE, PRODUCTS, AND/OR SERVICES VIA A LOCALIZED WIRELESS NETWORK

(76) Inventor: John Peter Norair, San Franscisco, CA (US)

(21) Appl. No.: 13/354,615

(22) Filed: Jan. 20, 2012

Related U.S. Application Data
(60) Provisional application No. 61/461,610, filed on Jan. 21, 2011.

(51) Int. Cl. G06F 15/173; H04W 24/00

(52) U.S. Cl. 709/224

(57) ABSTRACT

Electronic devices may exchange messages over a localized wireless network to discover persons, products, and/or services. The exchanged messages may comprise personalize messages that enable the users of the devices to connect (e.g., via a social networking website). The messages may enable the wireless exchange of feedback and recommendations. The messages may comprise advertisements which generate pay-per-click revenues. The messages may be generated and/or transmitted in accordance with a low-power wireless protocol such as ISO 18000-7.

### CLAIM OF PRIORITY

This patent application makes reference to, claims priority to and claims benefit from U.S. Provisional Patent Application Ser. No. 61/461,610 entitled “Method for Enabling an Entertainment System with a Wireless Network,” and filed on Jan. 21, 2011.

The above-stated application is hereby incorporated herein by reference in its entirety.

### INCORPORATION BY REFERENCE

This patent application also makes reference to:
U.S. Provisional Patent Application Ser. No. 61/464,376 entitled “Advanced Communication System for Wide-area Low Power Wireless Applications and Active RFID” and filed on Mar. 2, 2011;
U.S. patent application Ser. No. 13/267,640 entitled “Method and Apparatus for Adaptive Searching of Distributed Datasets” and filed Oct. 6, 2011;
U.S. patent application Ser. No. 13/270,802 entitled “Method and Apparatus for a Multi-band, Multi-mode Smartcard” and filed Oct. 11, 2011; and
U.S. patent application Ser. No. 13/354,513 entitled “Method and Apparatus for Memory Management” and filed on Jan. 20, 2012.

Each of the above-stated applications is hereby incorporated herein by reference in its entirety.

### FIELD OF THE INVENTION

Certain embodiments of the invention relate to wireless networking. More specifically, certain embodiments of the invention relate to a method and apparatus for discovering people, products, and services via a localized wireless network.

### BACKGROUND OF THE INVENTION

There currently exists no practical, user-friendly way of discovering products, people, and/or services of interest in a particular location. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for discovering people, products, and/or services via a localized wireless network, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

FIG. 1 is diagram of an exemplary device operable to discover persons, products, and/or services of interest via a localized wireless network.

FIGS. 2A-2C depict an exemplary exchange of messages for discovering persons, products, and/or services of interest from other devices that are in-range of a wireless interface.

FIGS. 3A-3B depict another exemplary exchange of messages for discovering persons, products, and/or services of interest from other devices that are in-range of a wireless interface.

FIG. 4 depicts an exemplary data structure in an electronic device which stores information regarding persons, products, and/or services which may be shared with other electronic devices.

### DETAILED DESCRIPTION OF THE INVENTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be implemented in hardware, software, firmware, or any combination of one or more thereof. As utilized herein, the term “exemplary” means serving as a non-limiting example, instance, or illustration. As utilized herein, the terms “e.g.,” and “for example,” introduce a list of one or more non-limiting examples, instances, or illustrations.

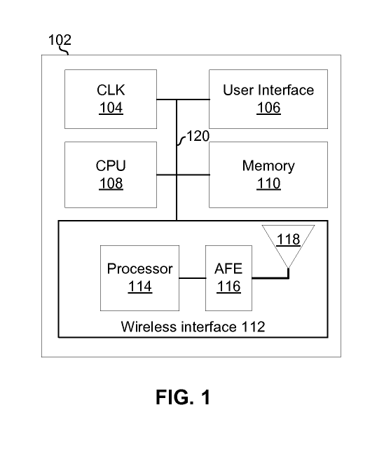

FIG. 1 is diagram of an exemplary device operable to discover persons, products, and/or services of interest via a localized wireless network. The exemplary electronic device 102 comprises a clock module 104, a CPU module 108, a user interface module 106, a memory module 110, and a wireless interface module 112 which, in turn, comprises a processing module 114, an analog front-end (AFE) module 116, and an antenna 118. The device 102 may be, for example, a portable music player, an electronic phone, a smartphone, a tablet computer, a laptop computer, an in-vehicle entertainment system, a home or office entertainment system, a television, a video monitor, and/or an e-book reader. The device 102 may be operable to store and/or present media content such as, for example, music, spoken word, movies, television, e-books, e-magazines, web content, games, and/or graphical user interface elements.

The clock 104 may be operable to generate one or more oscillating signals which may be utilized to control synchronous circuitry of the electronic device 102. The clock 104 may comprise, for example, one or more crystal oscillators, phase-locked loops, and/or direct digital synthesizers.

The user interface module 106 may comprise, for example, a display and an input device (e.g., keypad or touchscreen) that enable a user to interact with the device 102.

The CPU 108 may be operable to control operation of the device 102. The CPU 108 may, for example, execute instructions and perform arithmetic and/or logic operations in response to the executed instructions. The CPU 108 may generate one or more control signals for controlling the operation of the device 102.

The memory module 110 may comprise volatile memory operable to store runtime data and/or non-volatile memory operable to store data that is persistent over multiple power cycles of the device 102. The memory module 110 may comprise addressing/control logic which implements read and write operations in response to read and write commands issued to the memory module 110. In an exemplary embodiment, the memory may be managed as described in the above-incorporated U.S. patent application Ser. No. 13/354,513. In an exemplary embodiment, the memory module 110 may store data arranged as a Universal Data Block (UDB) as, for example, described below with respect to FIG. 5. In an exemplary embodiment, the memory module 110 may store data arranged as an Indexed Short File Block (IFSB) as described in above-incorporated U.S. Provisional Patent Application 61/464,376.

The wireless interface 112 may be operable to support wireless communications in accordance with one or more near-field and/or far-field wireless protocols. In an exemplary embodiment, the wireless interface 112 may support communications in accordance with, for example, Bluetooth, Low-Energy Bluetooth, Wi-Fi, WiMax, ANT, IEEE 802.15.4, ZigBee, cellular protocols, satellite communications protocols, protocols specified in ISO 18000-7, and/or protocols described in the above-incorporated U.S. Provisional Patent Application 61/464,376 filed on Mar. 2, 2011. The invention is not necessarily limited in regard to the frequencies on which the wireless interface 112 may communicate.

The processor 114 may comprise circuitry operable to interface with the AFE 116 to receive and transmit data, and to process received and to-be-transmitted data. For transmission, the processor 114 may be operable to receive data via the bus 120, packetize and/or otherwise process the data to prepare it for transmission in accordance with the wireless protocol(s) in use, and output the data to the AFE 116 for transmission. For reception, the processor 114 may be operable to receive data via the AFE 116, process the received data in accordance with the wireless protocol(s) in use, and output received data onto the bus 120.

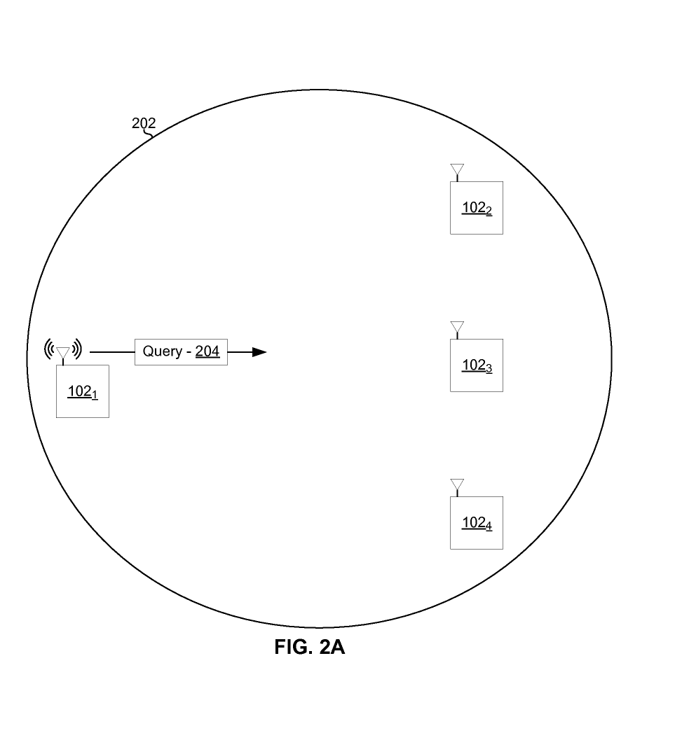

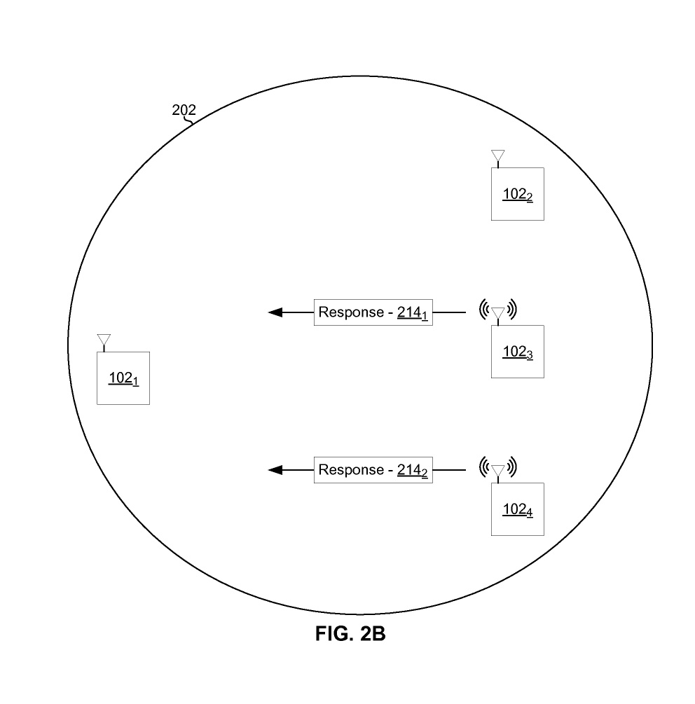

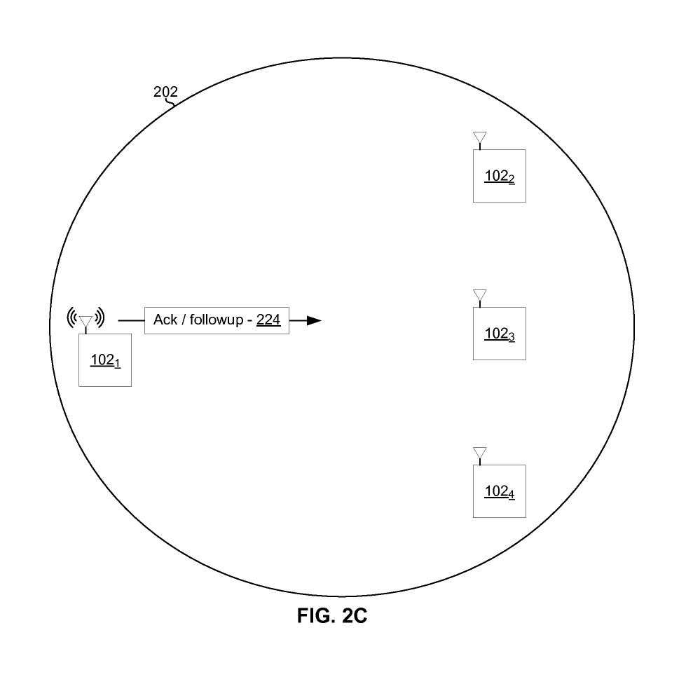

In operation, the device may exchange messages with other devices via the wireless interface 112 as shown, for example, in FIGS. 2A-4B. The communications with other devices may, for example, enable the device 102 to discover persons, products, and/or services. As an example, the communications may convey information about what other persons and/or devices are present in-range of the wireless interface 212. As another example, the communications may convey what media content is stored on the other devices, what media content is being consumed on the other devices, and/or what media content is recommended by users of the other devices. Similarly, the communications may convey recommendations and/or information about products and/or services other than media content (e.g., electronics, clothing/fashion, websites, nearby restaurants, etc.).

In an exemplary embodiment, messages conveyed to and/or from the device 102 may have embedded links associated with the persons, products, and/or services. In an exemplary embodiment, following the links (i.e., “clicking” the links) may result in the device that transmitted the link being rewarded (e.g., monetary compensation, credits, discounts and/or rewards points) for the referral.

FIGS. 2A-2C depict an exemplary exchange of messages for discovering persons, products, and/or services of interest from other devices that are in-range of a wireless interface. In FIGS. 2A-2C, there is shown a location 202 in which four devices, 102₁-102₄ are in communication range of one another. Each of the devices 102₁-102₄ may be an instance of the device 102 described in FIG. 1, for example.

In FIG. 2A, the device 102₁ transmits a discovery message 204. In FIG. 2B, the devices 102₃ and 102₄ (the “responding devices”) transmit discovery messages 214₁ and 214₂, respectively, in response to the message 204. In FIG. 2C, the device 102₁ transmits a discovery message 224 in response to receiving the messages 214₁ and 214₂.

In an exemplary embodiment, the message 204 comprises a query asking about media content. The query could ask, for example, what media content is stored on responding devices, what media content is currently being consumed on responding devices, and/or what media content is recommended by users of the responding devices. The messages 214₁ and 214₂ may provide responses to such questions. Additionally, one or both of the messages 214₁ and 214₂ may provide a Uniform Resource Locator (URL) providing more information about, and/or the option to purchase, the stored/consumed/recommended content. For example, the message 214₁ from the device 102₃ may recommend a favorite song and provide a link to an online retailer that sells the song.

In an exemplary embodiment of the invention, the message 204 may be a query seeking a recommendation, each of the messages 214₁ and 214₂ may provide such a recommendation, and the message 224 may indicate whether the recommendation was followed and a rating (or other feedback) of the recommendation. For example, in a restaurant, the message 204 may request a recommendation on what to eat, the message 214₃ may provide a recommendation, and the message 224 may indicate whether the recommended item was ordered and, if so, whether it was good.

In an exemplary embodiment, the message 204 may be a broadcast message destined for any device that it successfully reaches. Where the message 204 is a broadcast message, the device 102₂ may not respond because, for example, the device 102₂ did not receive the message (e.g., due to interference).

In an exemplary embodiment, the message 204 may be a multicast message destined for particular devices. Such particular devices may be selected based on any one or more filtering criteria. In such an instance, the device 102₂ may be excluded because it did not meet the criteria. For example, the message 204 may be destined only to: devices whose user is connected to the user of device 102₁ via a social networking website; devices whose users have previously indicated a preference for certain persons, products, or services; devices who have previously responded to a message from device 102₁; etc.

In an exemplary embodiment, the messages 214₁ and 214₂ may be sent automatically in response to the message 204. In an exemplary embodiment, the messages 214₁ and 214₂ may be sent only upon input from a user of the respective one of the devices 102₃ and 102₄. In an exemplary embodiment, the contents of the messages 214₁ and 214₂ may comprise predetermined (i.e., “canned”) language and/or content and/or may comprise language and/or content input by a user in response to receipt of the message 204.

In an exemplary embodiment, the message 224 may acknowledge reception of the messages 214₁ and 214₂. In an exemplary embodiment, the message 224 may provide a summary and/or aggregation of the information received in the messages 214₁ and 214₂ (and, potentially, other messages previously received). For example, the message 224 may indicate what the most popular content was among all responding devices, how many responding devices recommend particular content, how many devices are consuming particular content, etc. In an exemplary embodiment, the message 224 may comprise feedback from a user of the device 102₁ in response to one or both of the messages 214₁ and 214₂. For example, the message 224 may indicate that the user of the device 102₁ liked or did not like a recommendation in the message 214₁ from the device 102₃. Such feedback may, for example, be concurrently conveyed to a website which enables posting of such feedback (e.g., a social networking profile page associated with the user of device 102₃, a website which posts reviews/comments of products and/or services, etc.).

In an exemplary embodiment, one or more of the messages 204, 214₁, 214₂, and/or 224 may comprise a personalized message from and/or associated with a user of the device transmitting the message. For example, the message 204 may comprise a thumbnail or other image of a user of the device 102₁, an avatar or other unique representation of the user of the device 102₁, an audio recording made and/or selected by the user of the device 102₁, a video recording made and/or selected by the user of the device 102₁, an email address associated with the user of the device 102₁, a phone number associated with the user of the device 102₁, a handle associated with the user of the device 102₁ on one or more websites (e.g., one or more social networking websites), and/or a URL or other means of contacting or learning more about the user of the device 102₁. Each of the messages 214₁, 214₂, and 224 may comprise similar information from the user of the respective one of devices 102₁, 102₃, and 102₄.

In an exemplary embodiment, the message 204 may be triggered by various events and/or mechanisms. The message 204 may, for example, be generated and transmitted in response to reception of a wake up signal. The generation and transmission of the message 204 may, for example, be triggered by a sensor (e.g., motion sensor, RF energy detector, light sensor, GPS position, etc.) of the device 102₁. The generation and transmission of the message 204 may, for example, be triggered by a software-based rule implemented in device 102₁. The generation and transmission of the message 204 may, for example, be triggered by and/or in response to input from a user of the device 102₁.

In an exemplary embodiment, one or more of the messages 204, 214₁, 214₂, and 224 may be generated and/or transmitted in conformance with the ISO 18000-7 standard. Each of messages 204 and 224 may be, for example, a broadcast command, a point-to-point command, a Collection with Universal Data Block command, and/or a Read Universal Data Block command in conformance with ISO 18000-7. Each of messages 214₁ and 214₂ may be, for example, a broadcast response or a point-to-point response in conformance with ISO 18000-7.

In an exemplary embodiment, one or more of the messages 204, 214₁, 214₂, and 224 may be generated and/or transmitted in conformance with the protocols described in the above-incorporated U.S. Provisional Patent Application 61/464,376. Each of the messages 204, 214₁, 214₂, and 224 may comprise, for example, one or more background frames generated and/or transmitted utilizing one or both of the M2AdvP and/or M2ResP protocols described in U.S. Provisional Patent Application 61/464,376. Each of the messages 204, 214₁, 214₂, and 224 may comprise, for example, one or more foreground frames generated and/or transmitted in conformance with one or both of the M2DP and M2NP protocols described in U.S. Provisional Patent Application 61/464,376. Each of the messages 204, 214₁, 214₂, and 224 may, for example, be generated and/or transmitted in accordance with the M2QP protocol described in U.S. Provisional Patent Application 61/464,376. For example, each of the messages 204, 214₁, 214₂, and 224 may be an announcement command, an inventory command, a collection command, a request command, a propose command, an acknowledge command, or an application shell command.

In an exemplary embodiment, the exchange of messages depicted in FIGS. 2A-2C may be a search conducted as described in the above-incorporated U.S. patent application Ser. No. 13/267,640.

In an embodiment of the invention, the devices 102₃ and 102₄ may forward and/or retransmit the message 304 to, effectively, extend the range of the wireless interface 112 of the device 102₁. In another embodiment, however, the messages 304 may not be forwarded or retransmitted by other devices such that the discovery is limited to the range of the wireless interface 112 of the device 102₁. Along these lines, the device 102₁ may control its transmit power to adjust the area over which it conducts its discovery, for example, as is described in the above-referenced U.S. patent application Ser. No. 13/267,640.

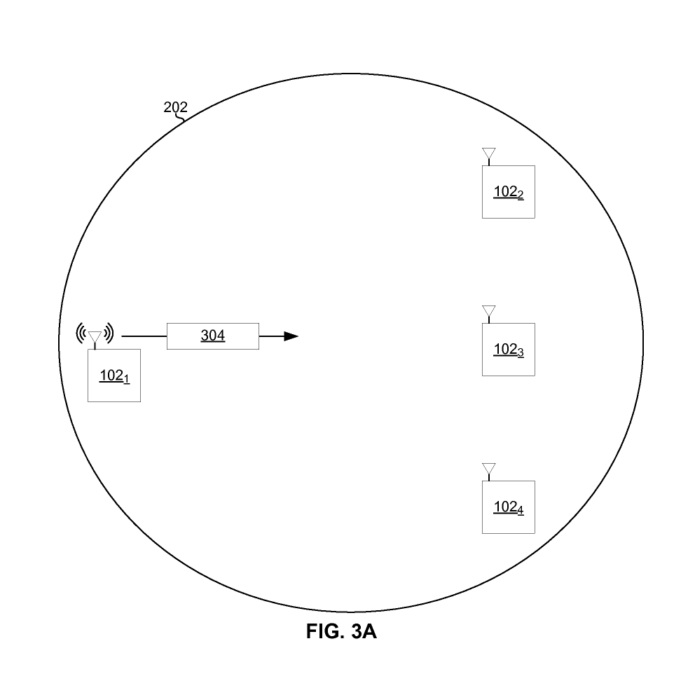

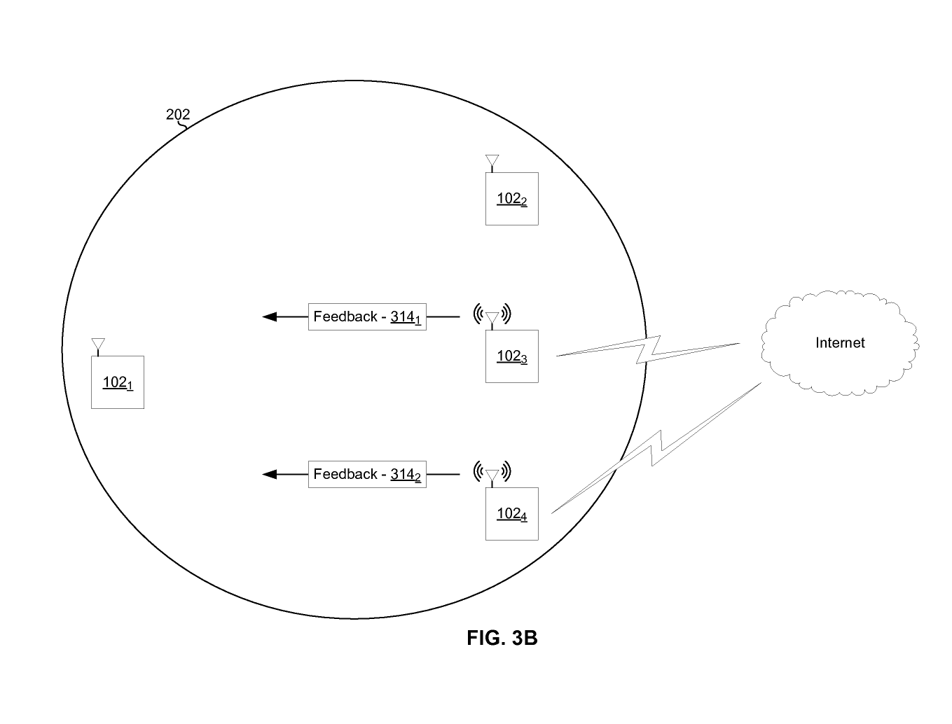

FIGS. 3A-3B depict another exemplary exchange of messages for discovering persons, products, and/or services of interest from other devices that are in-range of a wireless interface. In FIGS. 3A-3B, there is shown a location 202 in which four devices, 102₁-102₄ are in communication range of one another. Each of the devices 102₁-102₄ may be an instance of the device 102 described in FIG. 1.

In FIG. 3A, the device 102₁ transmits a discovery message 304. In FIG. 3B, the devices 102₃ and 102₄ (the “responding devices”) transmit discovery messages 314₁ and 314₂, respectively in response to the message 304.

In an exemplary embodiment, the message 304 comprises a status message that pertains to a status of the device 102₁ and/or the user of the device 102₁. The messages 314₁ and 314₂ may provide feedback commenting on the status of the device 102₁ and/or its user. For example, the message 304 may indicate an activity that the user of the device 102₁ is doing, a product that the user of the device 102₁ is using, and/or a service that the user of the device 102₁ is using. Accordingly, the messages 314₁ and 314₂ may indicate, respectively, how the users of the devices 102₃ and 102₄ rate the activity/product/service and/or whether the users would perform/purchase/use the activity/product/service.

In an exemplary embodiment, the devices 102₃ and 102₄ may communicate feedback to a web-based service in addition to and/or instead of the feedback in the messages 314₁ and 314₂. For example, concurrently with transmitting the message 314₁ (or sometime thereafter), the device 102₃ may submit the feedback to a website (e.g., a social networking profile associated with the user of the device 102₁ and/or associated with the product), the URL of which may have been provided as part of the message 304. The communication with the website may be via the wireless interface 112 or may be via another connection to the Internet.

In an exemplary embodiment, the message 304 may comprise an advertisement, and may comprise a URL and/or other mechanism for recipients of the message 304 to purchase the advertised product or service. In an exemplary embodiment of the invention, the URL may be associated with the device 102₁ and/or its user such that a “click-through” results in a reward (e.g., monetary compensation, credits, discounts and/or rewards points) being provided to the user of the device 102₁. In such an embodiment, each of the messages 314₁ and 314₂ may comprise a confirmation of the click-through sent directly to the device 102₁ while the device concurrently (or at some other time) connects to a website associated with the advertisement (e.g., via the wireless interface 112 and/or some other wired and/or wired interface).

In an exemplary embodiment, the message 304 may be a broadcast message destined for any device that it successfully reaches. In such an instance, the device 102₂ may not respond because, for example, the device 102₂ did not receive the message (e.g., due to interference).

In an exemplary embodiment, the message 304 may be a multicast message destined for particular devices. Such particular devices may be selected based on any of one or more filtering criteria. In such an instance, the device 102₂ may be excluded because it did not meet the criteria. For example, the message 304 may be destined only to: devices whose user is connected to the user of device 102₁ via a social networking website; devices whose users have previously indicated a preference for certain persons, products, or services; devices who have previously responded to a message from device 102₁; etc.

In an exemplary embodiment, one or both of the messages 314₁ and 314₂ may be sent automatically in response to the message 304. In an exemplary embodiment, one or both of the messages 314₁ and 314₂ may be sent only upon input from a user of the respective one of the devices 102₃ and 102₄. In an exemplary embodiment, the contents of the messages 314₁ and 314₂ may comprise predetermined (i.e., “canned”) language and/or content and/or may comprise language and/or content input by a user in response to receipt of the message 304.

In an exemplary embodiment, one or more of the messages 304, 314₁ and 314₂ may comprise a personalized message from and/or associated with a user of the device transmitting the message. For example, the message 304 may comprise a thumbnail or other image of a user of the device 102₁, an avatar or other unique representation of the user of the device 102₁, an audio recording made and/or selected by the user of the device 102₁, a video recording made and/or selected by the user of the device 102₁, an email address associated with the user of the device 102₁, a phone number associated with the user of the device 102₁, a handle associated with the user of the device 102₁ on one or more websites (e.g., one or more social networking websites), and/or a URL or other means of contacting or learning more about the user of the device 102₁. Each of the messages 314₁ and 314₂ may comprise similar information from a user of the respective one of the devices 102₃, and 102₄.

In an exemplary embodiment, the message 304 may be triggered by various events and/or mechanisms. The message 304 may, for example, be generated and transmitted in response to reception of a wake up signal. The generation and transmission of the message 304 may, for example, be triggered by a sensor (e.g., motion sensor, RF energy detector, light sensor, GPS position, etc.) of the device 102₁. The generation and transmission of the message 304 may, for example, be triggered by a software-based rule implemented in device 102₁. The generation and transmission of the message 304 may, for example, be triggered by and/or in response to input from a user of the device 102₁.

In an exemplary embodiment, one or more of the messages 304, 314₁, and 314₂ may be generated and/or transmitted in conformance with the ISO 18000-7 standard. The message 304 may be, for example, a broadcast command, a point-to-point command, a Collection with Universal Data Block command, and/or a Read Universal Data Block command in conformance with ISO 18000-7. Each of messages 314₁ and 314₂ may be, for example, a broadcast response or a point-to-point response in conformance with ISO 18000-7.

In an exemplary embodiment, one or more of the messages 304, 314₁, and 314₂ may be generated and/or transmitted in conformance with the protocols described in the above-incorporated U.S. Provisional Patent Application 61/464,376. Each of the messages 304, 314₁, and 314₂ may comprise, for example, one or more background frames generated and/or transmitted utilizing one or both of the M2AdvP and/or M2ResP protocols described in U.S. Provisional Patent Application 61/464,376. Each of the messages 304, 314₁, and 314₂ may comprise, for example, one or more foreground frames generated and/or transmitted in conformance with one or both of the M2DP and M2NP protocols described in U.S. Provisional Patent Application 61/464,376. Each of the messages 304, 314₁, and 314₂ may, for example, be generated and/or transmitted in accordance with the M2QP protocol described in U.S. Provisional Patent Application 61/464,376. For example, each of the messages 304, 314₁, and 314₂ may be an announcement command, an inventory command, a collection command, a request command, a propose command, an acknowledge command, or an application shell command. In an exemplary embodiment, the message 304 may comprise a collection command comprising a global query template which, in turn, comprises one or more of a compare length field, a compare code field, a compare mask field, and a compare value field, as described in the above-incorporated U.S. Provisional Patent Application 61/464,376.

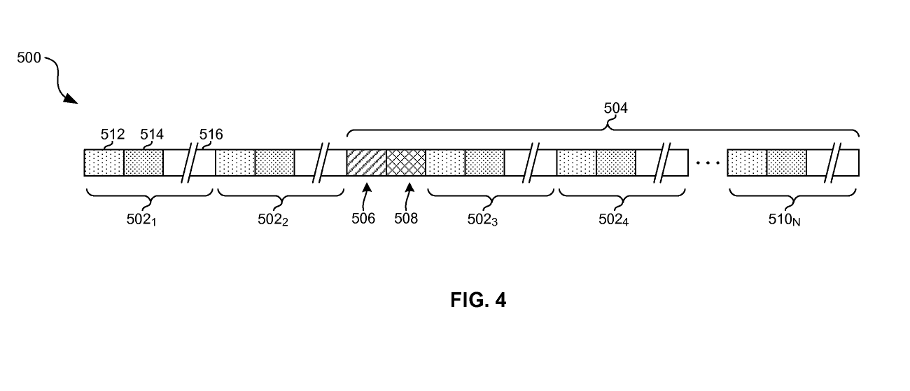

FIG. 4 depicts an exemplary data structure in an electronic device which stores information regarding persons, products, and/or services which may be shared with other electronic devices. In an exemplary embodiment, the Universal Data Block (UDB) 500 may be structured in conformance with ISO 18000-7.

The UDB 500 comprises a plurality of elements 502₁-502_{N}, each of which comprises a type field 512, a length field 514, and a value field 516. The elements 502₃-502_{N} may be part of the application extension block 504. The application extension may also comprise a field 506 indicating the beginning of the application extension block 504 and a field 508 indicating the length of the application extension block.

Each of the elements 502₃-502_{N} may store information about persons, products, and/or services. One or more of the elements 502₃-502_{N} may, for example, contain favorite products and/or services of the user of the device on which the UDB 500 is stored. One or more of the elements 502₃-502_{N} may, for example, contain products and/or services currently being used by the device on which the UDB 500 is stored. One or more of the elements 502₃-502_{N} may, for example, contain a personalized message generated by the user of the device on which the UDB 500 is stored. One or more of the elements 502₃-502_{N} may, for example, contain advertisements for products and/or services. One or more of the elements 502₃-502_{N} may, for example, contain information about a user of the device on which the UDB 500 is stored. The contents of the UDB 500 may be shared via message exchanges such as those described above with respect to FIGS. 3A-4B. For example, the contents of the UDB 500 may be transmitted in response to a received “Read UDB” or “Collection with UDB” command in conformance with ISO 18000-7.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for discovering people, products, and/or services via a localized wireless network.

Accordingly, the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method comprising:
transmitting, by a first electronic device via a first wireless interface, a first media content discovery message; and
receiving, by said first electronic device from a second electronic device that is within the wireless communication range of said first wireless interface of said first electronic device, a second media content discovery messages that was transmitted in response to said first media content discovery message, wherein said first media content discovery message and said/or said second media content discovery message comprises a personalized message.

2. The method of claim 1, wherein said personalized message comprises a user image, an audio recording, a video recording, an email address, a phone number, and/or a social networking uniform resource locator (URL).

3. The method of claim 1, wherein said first media content discovery message is triggered: in response to one of reception of a wake up signal, by a sensor of said first electronic device, by a software-based rule implemented in said first electronic device, and/or in response to input from a user of said second electronic device.

4. The method of claim 1, wherein said second media content discovery message comprises information about media content stored on said second electronic device.

5. The method of claim 4, wherein said second media content discovery message comprises information about media content currently being consumed on said second electronic device.

6. The method of claim 4, wherein said second media content discovery message comprises media content recommendations from a user of said second electronic device.

7. The method of claim 1, comprising transmitting, by said first electronic device via said first wireless interface, a third media content discovery message in response to said second media content discovery message.

8. The method of claim 7, wherein said third media content discovery message comprises feedback from a user of said first electronic device regarding the information contained in said second media content discovery message.

9. The method of claim 7, wherein said third media content discovery message and/or said first media content discovery message comprises information about other electronic devices in-range of said first electronic device, said information having been received via second media content discovery messages from said other electronic devices.

10. The method of claim 1, comprising submitting a comment to a social networking website associated with said second electronic device and/or its user, in response to said second media content discovery message.

11. The method of claim 1, wherein said first media content discovery message comprises information about media content stored on said first electronic device.

12. The method of claim 11, wherein said first media content discovery message comprises information about media content currently being consumed on said first electronic device.

13. The method of claim 12, wherein said second media content discovery message indicates that said media content currently being consumed on said first electronic device is currently being consumed on said second electronic device.

14. The method of claim 11, wherein said first media content discovery message comprises media content recommendations from a user of said first electronic device.

15. The method of claim 1, wherein said second media content discovery message comprises feedback from a user of said second electronic device regarding the information contained in said first media content discovery message.

16. The method of claim 15, wherein said feedback is concurrently submitted to a social networking site associated with said first electronic device.

17. The method of claim 1, wherein said first media content discovery message comprises a uniform resource locator (URL) which, when clicked, provides a reward to the user of said first electronic device.

18. The method of claim 1, wherein said second media content discovery message comprises a uniform resource locator (URL) which, when clicked, provides a reward to the user of said second electronic device.

19. The method of claim 1, wherein said first media content discovery message and/or said second media content discovery message is generated and transmitted in conformance with the ISO 18000-7 standard.

20. The method of claim 19, wherein said first media content discovery message is either an ISO 18000-7 Collection with Universal Data Block command, or an ISO 18000-7 Read Universal Data Block command.

21. The method of claim 19, wherein said first media content discovery message comprises a global query template.

22. A method comprising:
broadcasting, by a first electronic device via a first wireless interface, a message conveying information about a person, product, and/or service; and
receiving, by said first electronic device from a second electronic device that is within the wireless communication range of said first wireless interface of said first electronic device, a second message that was transmitted in response to said first message, wherein said second message comprises feedback about said person, product, and/or service from a user of said second electronic device.

23. The method of claim 22, wherein said first message comprises a uniform resource locator (URL) for contacting said user of said first electronic device.

24. The method of claim 22, wherein said first message comprises a uniform resource locator (URL) which, when clicked, provides a reward to the user of said first electronic device.

25. The method of claim 122, wherein said second message comprises a uniform resource locator (URL) which, when clicked, provides a reward to the user of said second electronic device.

26. The method of claim 22, wherein said first message and/or said second message is generated and transmitted in conformance with the ISO 18000-7 standard.

27. The method of claim 22, wherein said first message is either an ISO 18000-7 Collection with Universal Data Block command, or an ISO 18000-7 Read Universal Data Block command.

28. The method of claim 22, wherein said first message comprises a global query template.
